(19) United States
(12) Patent Application Publication
(10) Pub. No.: US 2007/0241554 A1
(43) Pub. Date: Oct. 18, 2007

(54) SURVIVABLE SECURITY FEATURES FOR IMAGE REPLACEMENT DOCUMENTS

(75) Inventors: Thomas Wicker, Hemlock, NY (US); David M. Wicker, Dansville, NY (US); Michael Scott Caton, Oakfield, NY (US)

Correspondence Address: Stephen B. Salai, Esq.;Harter, Secrest & Emery LLP, 1600 Bausch & Lomb Place, Rochester, NY, 14604-2711, US

(73) Assignee: DOCUMENT SECURITY SYSTEMS, INC., Rochester, NY (US)

(21) Appl. No.: 11/686,806

(22) Filed: Mar. 15, 2007

Related U.S. Application Data
(63) Continuation-in-part of application No. 11/683,161, filed on Mar. 7, 2007.
Application No. 11/683,161 is a continuation-in-part of application No. PCT/US05/31440, filed on Sep. 6, 2005.
(63) Continuation-in-part of application No. 10/895,822, filed on Jul. 22, 2004.
Application No. 10/895,822 is a continuation of application No. PCT/US03/32159, filed on Oct. 9, 2003.
(60) Provisional application No. 60/795,167, filed on Apr. 27, 2006.
(60) Provisional application No. 60/607,272, filed on Sep. 7, 2004.
(60) Provisional application No. 60/655,424, filed on Feb. 24, 2005.
(60) Provisional application No. 60/417,751, filed on Oct. 10, 2002.
(60) Provisional application No. 60/417,752, filed on Oct. 10, 2002.
(60) Provisional application No. 60/417,753, filed on Oct. 10, 2002.
(60) Provisional application No. 60/417,754, filed on Oct. 10, 2002.
(60) Provisional application No. 60/417,755, filed on Oct. 10, 2002.
(60) Provisional application No. 60/417,756, filed on Oct. 10, 2002.
(60) Provisional application No. 60/417,757, filed on Oct. 10, 2002.
(60) Provisional application No. 60/417,758, filed on Oct. 10, 2002.

(51) Int. Cl. B42D 15/10

(52) U.S. Cl. 283/93; 283/72

(57) ABSTRACT

A security image embedded in an original printed document survives a conversion process into an image replacement document in binary image form having a commercial equivalency with the original printed document. The security image is embedded in a background at an approximately common visual density with the background so that the security image is at least partially indistinguishable from the background to the naked eye. Print elements of the security image are arranged differently than the print elements of the background and both are further arranged so that that upon conversion into the image replacement document in binary image form, the security image survives and the background drops out.

### CROSS-REFERENCE TO RELATED APPLICATIONS

This application is (a) a nonprovisional of U.S. Provisional Application No. 60/795,167, filed on Apr. 27, 2006, (b) a continuation-in-part of U.S. application Ser. No. 11/683,161 filed on Mar. 7, 2007, which is a continuation-in-part of International Application No. PCT/US2005/031440, filed on Sep. 6, 2005, and (c) a continuation-in-part of U.S. application Ser. No. 10/895,822, filed Jul. 22, 2004, which is a continuation of International Application No. PCT/US2003/032159, filed Oct. 9, 2003, which are all hereby incorporated by reference.

### TECHNICAL FIELD

This invention relates generally to document protection methods and products. More particularly, the present invention relates to methods and products for printing or otherwise preparing original documents containing security features that are preserved in electronic reproductions of the documents (e.g., security features that survive the scanning process). In addition, the invention relates to document processing systems and methods of use in which security images embedded in original documents function to authenticate electronic reproductions of the documents for such purposes as facilitating paperless transactions and authenticating and validating archived documents.

### BACKGROUND OF THE INVENTION

Many methods and products have been developed to deter counterfeiting of valuable papers, important records, or financial instruments, such as checks and currency, so that unauthorized copies of these documents can be readily distinguished from the originals. Most of these methods and products involve preparing an original document by printing on high quality media such as silk, rice paper, and high content rag paper. The printing of original documents can be done either in black-and-white (B&W) or in color, and if in color, either in spot color, colored backgrounds and/or multicolor printing. Multiple colors are often preferred for original documents for aesthetic value, for ease of recognition, and originally for protection from copying. The common printing processes of valuable originals, whether in B&W or in color, include intaglio (e.g., gravure) and offset printing, among others. These and the other processes mentioned in this application are very well known in the art and will not be discussed in further detail.

Most known approaches for deterring counterfeiting or other unauthorized reproductions of valuable documents are intended to ensure that copies are distinguishable from the originals by acquiring a distinct moiré distortion or by revealing a “latent image” indicia bearing a warning message that is invisible or nearly invisible to the naked eye on the original document. The term “latent image” is used here not in the photographic sense of an unseen image to be developed after processing by chemical reaction, but to indicate indicia that are printed on originals so as to be nearly invisible to the naked eye under normal viewing conditions (e.g., through a limited range of viewing angles).

These and other developments in the prior art for purposes of providing document protection are disclosed in the patent literature, as for example, in U.S. Pat. No. 5,018,767 issued May 28, 1991; U.S. Pat. No. 5,193,853 issued Mar. 16, 1993; and U.S. Pat. No. 3,675,948 issued Jul. 11, 1972; and U.S. Pat. No. 4,143,967 issued Mar. 13, 1979, all to Ralph C. Wicker; in U.S. Pat. No. 4,227,720 issued Oct. 14, 1980 and U.S. Pat. No. 4,310,180 issued Jan. 12, 1982, both to William H. Mowry, et al, as well as U.S. Pat. No. 5,149,140 issued Sep. 22, 1992 to Mowry et al; and in U.S. Pat. No. 5,487,567 issued Jan. 30, 1996 to John R. Volpe. All of these patents disclose various means for providing methods and products to enable copies of documents to be distinguished from the originals, as for example, by a “large dot-small dot pattern”, a “close line-spaced pattern”, and images or indicia which are screen printed at minutely varied spaces and/or angles on the originals and are intended to produce a highly visible moiré pattern effect on the unauthorized copies. In this specification, the words “print”, “printed” and “printing” are used to refer to the making of an original document by any of a number of known printing means, including transferring images from one source to another, typically a paper medium, using a transfer agent such as ink or toner. The words “copy” and “copying” to refer to making copies from an original printed document.

A significant commercial use of security images is in commercial paper, such as personal checks. Personal checks conventionally originate from a particular banking institution and often bear one or more security images, either latent images or non-latent images, associated with the originating banking institution. When a personal check is presented to another banking institution for payment of a debt, the paper copy of the check is typically returned to the originating bank, which may use the security images to verify that the check is a valid check.

However, under a new U.S. Federal Reserve regulation called “Check 21” (based on the Check Clearing for the 21^{st} Century Act of 2004), banks at which checks are deposited are no longer be required to return the original paper check to the bank on which the check has been drawn. Instead, the originating bank receives only electronic images or scans of its checks (referred to as “image replacement documents” or “IRDs”) from the banks at which the checks have been deposited. In paper form, the image replacement documents, also referred to as “substitute checks”, have a legal equivalency to the original check. This regulation is expected to allow a considerable savings in transaction costs for the banking industry by avoiding the need to sort and physically transport the paper checks to their originating bank.

However, security images contained on conventional commercial paper, such as original checks, do not survive the scanning process, i.e. they are not reproduced in the scanned copy of the original check as an image replacement document. Accordingly, the originating bank cannot as effectively verify if the image replacement document returned from the depositing bank is a valid check. The difficulty in verifying the authenticity of image replacement documents raises significant concerns over the potential for increased check fraud once the new “Check 21” regulations become more widely adopted. While the “Check 21” regulations significantly speed the handling and collection of checks, the risk of unprosecutable check fraud losses is raised, because the conversion process destroys at least some of the evidence of fraud.

To counter such fraud in a cost-effective manner, it would be desirable to have a security technology that is captured as a normal part of the electronic conversion process for authenticating the electronic replacement documents. Ideally, the new security technology would require no significant additional expenses or modifications to the printing systems for producing original documents or to the hardware platforms already in place for converting the original documents.

However, the current security images on conventional commercial documents do not survive the scanning process of the conventional scanners used in the banking industry. The banking industry uses relatively high speed, low-resolution scanners (e.g., producing images in the range of 200 to 240 pixels per inch). The result is a generic binary image generated from a grayscale image scan by comparing reflectance values against a threshold. The image replacement documents are transmitted and stored as binary images, which necessarily involves some loss of information, and the conventional security images are particularly vulnerable to such loss. That is, the subtle printing details that enable known security images to thwart copying do not survive the conversion process into binary images of the commercial paper.

Additionally, there is a need to provide security technology that distinguishes an unauthorized copy of a printed document, such as a check, from an original yet is able to survive the scanning process and low-resolution conversion into a binary image, such as performed by the current generation of check processing equipment used by the banking industry. Ordinarily, security features are intended to distinguish copies as unauthorized reproductions of original printed documents. Here, however, the image replacement documents have a commercial, if not also legal, equivalency with the original printed documents and require authentication as copies. Thus, what needs to survive the electronic conversion is not an indication that the image replacement document is an unauthorized copy unless it is an image of an unauthorized copy but, instead, an indication that the image replacement document is itself an authorized copy of the original printed document.

### SUMMARY OF THE INVENTION

The invention among its preferred embodiments overcomes many such known problems, including problems associated with authenticating of image replacement documents. Featured among the embodiments are security technologies that are particularly effective for authenticating image replacement documents in paper or electronic form that are intended as commercial or legal equivalents to original printed documents. The security features include validating latent images that survive a lower-resolution conversion of an original printed document to an electronic form (such as by scanning) and invalidating latent images that survive a higher-resolution reproduction of that original printed document in a paper form but do not survive the lower-resolution conversion to the electronic form. In addition, the invalidating latent images can be arranged survive a lower-resolution conversion of the higher-resolution reproduction (i.e., paper copy) of the original printed document to distinguish a scan of the paper copy from a scan of the original printed document.

The invention is useful for authenticating and validating a variety of documents that are converted into an electronic form, particularly a binary image form, for such purposes as conducting electronic transactions or managing an archive. These documents include financial instruments, corporate, tax and real estate transactions or other dealings, public records, and publications, which when originally printed are modified to incorporate security images that survive conversion into an electronic form as evidence that the resulting image replacement documents can be treated as commercial or legal equivalents. In fact, the invention allows newly printed documents, regardless of their contents, to be credentialed in such a way that the authenticity of electronic reproductions can be verified. The original printed documents, so credentialed, can be stored in an archive to authenticate electronic reproductions, or the authenticated electronic reproductions themselves can form a regularly accessible or historic archive.

One version of the invention is a document processing system in which a security image embedded in an original printed document survives a conversion process into an image replacement document in binary image form having a commercial or legal equivalency with the original printed document. The security image is embedded in a background of the original printed document at an approximately common visual density with the background so that the security image is at least partially indistinguishable from the background to the naked eye. Both the security image and the background are formed by an arrangement of relatively oriented print elements. The print elements of the security image are arranged at a different spatial frequency than the print elements of the background. The approximately common visual density is set in relation to the different spatial frequencies so that upon conversion into the image replacement document in binary image form, the security image is converted into a different ratio of dark vs. light pixels than the background and thereby becomes more readily distinguishable from the background.

For example, the ratio of dark vs. light pixels in the background can be reduced with respect to the ration of dark vs. light pixels in the securing image upon conversion into the image replacement document in binary image form. The dark and light pixels within the binary image correspond to reflectance-sampled regions of the original printed document, and the security image print elements are preferably sized in relation to both the background print elements and the reflectance-sampled regions so that the reflectance-sampled regions of the security image exhibit more highly contrasting reflectance values than the sampled regions of the background.

The print elements of the security image can be oriented in a first direction and can have a first spatial frequency, and the print elements of the background can be oriented in a second direction and can have a second frequency that is one half or less than the first frequency. The approximately common visual density of the security image and the background is preferably less than 50 percent and more preferably 20 percent to 30 percent with approximately 25 percent considered optimal. The first frequency is preferably less than 105 lines per inch, and the second frequency of the background print elements is preferably greater than 105 lines per inch. More preferably, the first frequency is between 50 and 85 lines per inch and the second frequency is between 150 and 190 lines per inch, with a first frequency of 75 lines per inch and a second frequency of 180 lines per inch considered optimal. The security image can include a message, code, picture, portrait, design, or indicia.

For purposes of presenting a substitute check, the image replacement document can be reproduced in a paper form meeting requirements for legal equivalence with the original printed document under the Check Clearing for the 21^{st} Century Act of 2004.

The security image can be a first of more than one security image, the background can be a first of more than one background, and a second of the more than one security images and a second of the more than one background can exhibit an approximately common visual density so that the second security image is at least partially indistinguishable from the background to the naked eye. The common visual density of the second security image and the second background is preferably less than the common visual density of the first security image and the first background. Preferably, the common visual density of the second security image and the second background is less than 20 percent, more preferably between 5 percent and 20 percent, and optimally at approximately 14 or 15 percent, and the common visual density of the first security image and the first background is more than 20 percent, more preferably between 20 percent and 30 percent and optimally at 25 percent.

Alternatively, the first and second backgrounds can have matching visual densities, and the print elements of the first and second backgrounds can even have the same spatial frequencies. However, the print elements of the first and second security images preferably have different spatial frequencies.

Both the first security image and the second security image have visual densities and print elements relatively arranged to survive a grayscale reproduction of the original printed document in a paper form. The first security image also has a visual density and print elements relatively arranged to survive a dynamic contrast image conversion of the original printed document into the image replacement document in binary image form, but the second security image does not have a visual density and print elements relatively arranged to survive the same dynamic contrast image conversion of the original printed document into the image replacement document in binary image form. However, the second security image preferably survives a dynamic contrast image conversion of the paper form of the grayscale reproduction into the image replacement document in binary image form. The first security image is preferably a validating security image, and the second security image is preferably an invalidating security image, such that the appearance of the second security image in either the paper form of the grayscale reproduction or the binary image form of the image replacement document is indicative of an unauthorized reproduction.

Another version of the invention as a method of authenticating image replacement documents as commercial equivalents of original printed documents includes scanning an original printed document containing a security image embedded in a background at an approximately common visual density with the background such that the security image is at least partially indistinguishable from the background to the naked eye. Reflectance values are acquired from reflectance-sampled regions of the scanned original printed document. Print elements of the security image are sized in relation to both print elements of the background and the reflectance-sampled regions of the scanned original print document such that the reflectance-sampled regions of the security image exhibit more highly contrasting reflectance values than the reflectance-sampled regions of the background. An image replacement document is generated in binary image form from the reflectance values of the reflectance-sampled regions of the scanned original printed document such that the more highly contrasting reflectance values of the reflectance-sampled regions of the security image are converted into a different ratio of dark vs. light pixels than the reflectance-sampled regions of the background, thereby rendering the security image more readily distinguishable from the background. The security image is detected in the image replacement document to verify the authenticity of the image replacement document as a commercial equivalent of the original printed document.

Preferably, the ratio of dark vs. light pixels in the background is reduced with respect to the ratio of dark vs. light pixels in the security image within the image replacement document in binary image form. Generating the image replacement document can involve comparing the reflectance values to a threshold such that a different percentage of the reflectance values of the reflectance-sampled regions of the security image meet the threshold than the reflectance values of the reflectance-sampled regions of the background.

The method also preferably includes printing the security image and the background as arrangements of relatively oriented print elements, wherein the print elements of the security image are arranged at a lower spatial frequency than the print elements of the background. Preferably, the spatial frequency of the security feature print elements is one half or less than the spatial frequency of the background print elements. More preferably, the spatial frequency of the security feature print elements is between 50 lines per inch and 85 lines per inch and the spatial frequency of the background print elements is between 150 lines per inch and 190 lines per inch, and optimally the spatial frequency of the security feature print elements is approximately 75 lines per inch and the spatial frequency of the background print elements is approximately 180 lines per inch. In addition, the print elements of the security image and the background are oriented relative to each other through an angle of at least five degrees to obscure visual distinctions between the security feature and the background.

The approximately common visual density of the security image and the background is preferably less than 50 percent. More preferably, the approximately common visual density of the security image and the background is between 20 percent and 30 percent, and optimally, the approximately common visual density is approximately 25 percent.

The step of detecting can include reproducing the image replacement document in a paper form that meets requirements for legal equivalence with the original printed document under the Check Clearing for the 21^{st} Century Act of 2004. For example, the original printed document can be an endorsed paper check, and the image replacement document can be a substitute check in accordance with the act. The security image can be a security icon that is not readily visible to the naked eye in the original paper check, but the security icon can appear visible to the naked eye in an unobtrusive section of the substitute check. Consistent with the use of commercial bank scanners, the step of acquiring reflectance values from reflectance-sampled regions of the scanned original printed document includes acquiring the reflectance values from the sampled regions at a density of no more than 300 samples per inch, and more generally between 200 samples per inch and 240 samples per inch.

The security image can be a first of more than one security image, the background can be a first of more than one background, and a second of the more than one security images and a second of the more than one background can exhibit an approximately common visual density so that the second security image is at least partially indistinguishable from the background to the naked eye. The common visual density of the second security image and the second background is preferably less than the common visual density of the first security image and the first background such that the second security image does not survive as a distinguishable feature in the image replacement document through the step of generating the image replacement document in binary image form based on the reflectance values of the reflectance-sampled regions of the scanned original printed document. The first security image can be a validating security image and the second security image can be an invalidating security image, such the appearance of the second security image in the image replacement document is indicative of an unauthorized reproduction of the original printed document.

The print elements of the second security image can be sized in relation to both print elements of second background and the print elements of the first security image such that the reflectance-sampled regions of the first security image exhibit more highly contrasting reflectance values than reflectance-sampled regions of the second security image. As a result, the second security image does not survive as a distinguishable feature in the image replacement document through the step of generating the image replacement document in binary image form based on the reflectance values of the reflectance-sampled regions of the scanned original printed document. The common visual density of the second security image and the second background can also be substantially the same as the common visual density of the first security image and the first background.

Another version of the invention is a document having survivable and non-survivable security images. A validating security image is embedded in a first background of the document at an approximately common visual density so that the validating security image is at least partially indistinguishable from the first background to the naked eye. An invalidating security image is embedded in a second background at an approximately common visual density so that the invalidating security image is at least partially indistinguishable from the second background to the naked eye. The two security images and the two backgrounds are formed by arrangements of relatively oriented print elements having respective spatial frequencies. The validating and invalidating security images exhibit at least one of different spatial frequencies and different visual densities. The visual densities of the validating sand invalidating security images being set in relation to the spatial frequencies of the validating and invalidating security images so that the validating security image survives a conversion of the document into an electronic form and the invalidating security image does not similarly survive the same conversion into the electronic form.

Preferably, the common visual density of the validating security image and the first background is more than 20 percent, and the common visual density of the invalidating security image and the second background is less than 20 percent. More particularly, the common visual density of the validating security image and the first background is preferably between 20 percent and 30 percent and optimally 25 percent, and the common visual density of the invalidating security image and the second background is preferably between 5 percent and 20 percent and optimally at 14 percent or 15 percent.

Alternatively, the visual density of the first background can match the visual density of the second background. In such instance, the spatial frequency of the print elements of the validating security image is preferably less than the spatial frequency of the print elements of the invalidating security image.

Both the validating security image and the invalidating security image can have visual densities and print elements relatively arranged to survive a higher-information-content reproduction of the document in a paper form, the validating security image can have a visual density and print elements relatively arranged to survive a lower-information-content conversion of the document into the electronic form, but the invalidating security image does not have a visual density and print elements relatively arranged to survive the same lower-information-content conversion of the document into the electronic form. The invalidating security image preferably survives a lower-information-content conversion of the paper form of the higher-information-content reproduction into the electronic form. The appearance of the invalidating security image in either (a) the paper form of the higher-information-content reproduction or (b) the electronic form of the lower-information-content conversion is indicative of an unauthorized reproduction.

The validating security image and the invalidating security image can be located in adjacent portions of the document and a joined by a third background that blends the higher visual density of the validating security image and the first background with the lower visual density of the invalidating security image and the second background.

Another version of the invention is a printed document containing security features for authenticating an image replacement document that is electronically converted from the printed document. A validating security feature and an invalidating security feature are embedded in the printed document in forms that are at least partially invisible to the naked eye. The validating security feature is arranged to survive a conversion of the printed document into a binary image. The invalidating security feature is arranged to survive a conversion of the printed document into a grayscale reproduction but to not survive the conversion of the printed document into the binary image.

The validating security feature can be located in an unobtrusive section of the printed document to avoid obscuring otherwise printed regions of the printed document, and the invalidating security feature can be located in an obtrusive section of the printed document to at least partially obscure the otherwise printed regions of the printed document upon the conversion into the grayscale reproduction. The invalidating security feature is arranged to survive a further conversion of the grayscale reproduction of the printed document into the binary image as evidence of an unauthorized reproduction of the printed document.

The printed document can be a paper check and the image replacement document can be arranged to meet requirements of the Check Clearing Act for the 21^{st} Century of 2004 for an electronic conversion of the paper check. The image replacement document as a substitute check can be based on the binary image of the paper check.

Yet another version of the invention involves a method of creating authenticating image replacement documents as commercial equivalents of original printed documents. A security image is embedded in a background of an original printed document at an approximately common visual density with the background so that the security image is at least partially indistinguishable from the background to the naked eye. Both the security image and the background are formed by an arrangement of relatively oriented print elements. The print elements of the security image are arranged at a different spatial frequency than the print elements of the background. The common visual density is set in relation to the different spatial frequencies so that upon conversion of the original printed document into the image replacement document in a binary image form, the security image is converted into a different ratio of dark vs. light pixels than the background and thereby becomes more readily distinguishable from the background.

The common visual density can be set in relation to the different spatial frequencies so that the ratio of dark vs. light pixels in the background is reduced with respect to the ratio of dark vs. light pixels in the security image upon conversion into the image replacement document in binary image form. The print elements of the security image are preferably arranged at a first spatial frequency and the print elements of the background are preferably arranged at a second spatial frequency that is one half or less than the first frequency. In particular, the first frequency can be between 50 lines per inch and 85 lines per inch and the second frequency can be between 150 lines per inch and 190 lines per inch. The common visual density of the security image and the background is preferably between 20 percent and 30 percent.

Among these embodiments, the invention extends security to image replacement documents intended to have commercial or legal equivalence to paper checks and other negotiable instruments or otherwise valuable printed documents. Security images that are hidden in the paper documents survive the conversion to image replacement documents in binary image form to authenticate the image replacement documents.

### BRIEF DESCRIPTION OF THE DRAWING FIGURES

The accompanying drawings, which are incorporated in and form a part of the specification, together with the description serve to explain the principles of the invention.

FIG. 1 depicts an original printed document in the form of a bank check in which latent security images are embedded in the background.

FIG. 2 is an enlarged portion of the bank check indicated at 2 in FIG. 1 and showing line patterns of a validating security image within a background.

FIG. 3 is another enlarged portion of the bank check indicated at 3 in FIG. 1 and showing line patterns of an invalidating security image within a background.

FIG. 4 depicts a scanned image of the bank check of FIG. 1 as an image replacement document in which the validating security feature is reproduced as evidence of authenticity.

FIG. 5 depicts a scanned image of a copy of the bank check of FIG. 1 in which the invalidating security feature is reproduced as evidence of an unauthorized reproduction.

FIG. 6 is an exemplary test pattern that may be used to determine survivable and non-survivable frequencies of scanning platforms;

FIG. 7 is a diagram of a document processing system for converting an original printed document, such as depicted FIG. 1, into an image replacement document, such as depicted in FIG. 5 as a commercial or legal equivalent of the original printed document.

### DETAILED DESCRIPTION OF THE INVENTION

One embodiment of the invention, which has particular benefits for the banking industry, features a cost effective security feature in the form of a latent (covert) security image that can survive the imaging process on the check processing technology currently in use. The survivable security image enables originating banks to assure the authenticity of the new electronic checks under the standards adopted for the Check Clearing Act for the 21^{st} Century of 2004, referred to as “Check 21” standards. The invention can also be practiced under the industry standards published by the Accredited Standards Committee X9, Incorporated. Significantly, no expensive software or hardware is necessary to utilize the advance.

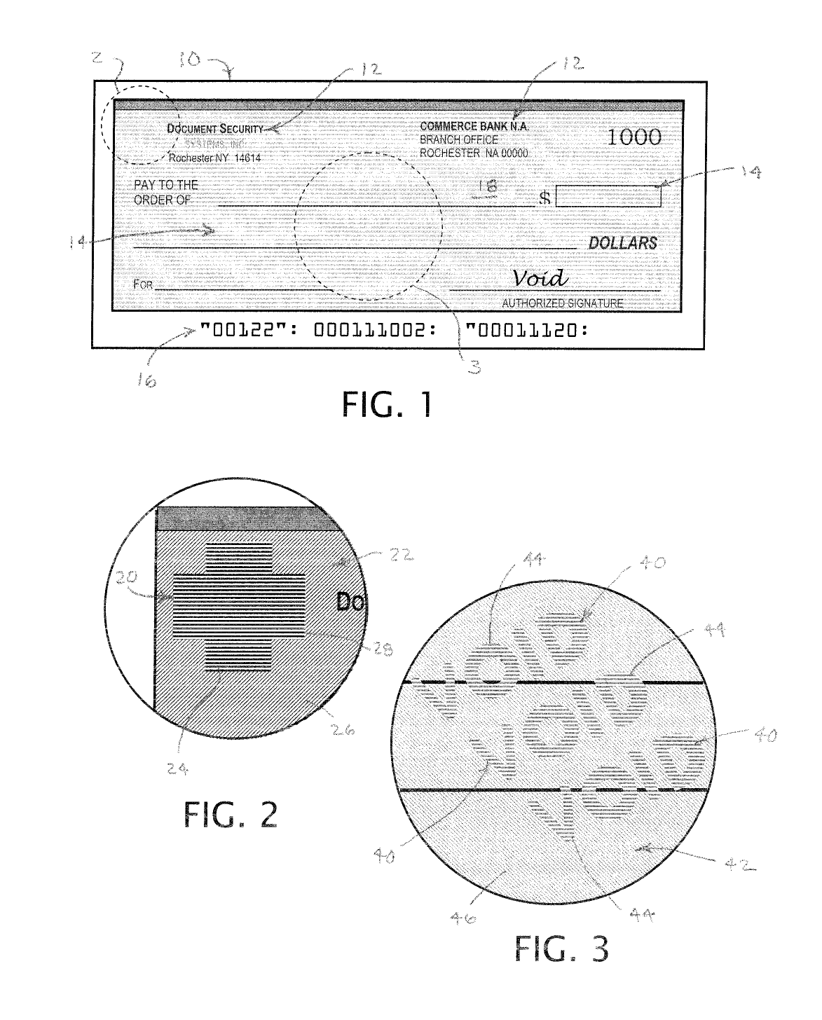

Referring to the drawings for more details of the embodiment, an original printed document in the form of a bank check 10 is shown in FIG. 1 having a number of preprinted areas 12, containing information about the payor and the payor bank, along with designated fillable areas 14 (data element fields) for entering necessary or desired information for the payor bank to convey funds or track payments to an intended payee.

Except for a magnetic ink character recognition (MICR) strip 16 along the bottom of the check 10, the preprinted areas 12 and the designated fillable areas 14 are printed against a background 18, which hides security features. For example, within the area 2, shown enlarged in FIG. 2, a validating security feature in the form of a latent (covert) security image 20 is embedded in a complementary background 22, which comprises a portion of the background 18. The security image 20 is composed of a patterned array of print elements arranged as regularly spaced horizontal lines 24 at a first spatial frequency (measured in lines per inch), and the background 22 is composed of a complementary pattern of print elements also arranged as regularly space lines 26 but at a different angular orientation and spatial frequency. (The term “lines” as used in this application means solid lines, dots or spots or any other printing technique to form a line in an image, and the line frequencies and visual densities discussed herein apply to lines, dots, or spots.) The security image 20 and its complementary background 22 match in both color and visual density (i.e., the inverse measure of the reflectance or the relative brightness of the image as seen by the human eye) so that the security image 20 is at least partially indistinguishable from the background 22 to the naked (unaided) eye.

The different angular orientations of the security image lines 24 and the background lines 26 assure that the respective lines to reach intersections at a boundary 28 around the security image 24, which helps to blend the security image 20 within the background 22. Although depicted at an angular difference of 45 degrees, the security image lines 24 and the background lines 26 can be relatively oriented through a range of angles to accomplish this purpose. However, at least a five-degree angular difference is generally preferred.

The spatial frequency of the background lines 26 is substantially higher than the spatial frequency of the security image lines 24, preferably by a factor of two or more. Given the common visual density of both the security image 20 and its complementary background 20 the variation spatial line frequency results in a corresponding inverse variation in the respective line thicknesses of the security image lines 24 and the background lines 26. That is, the line thicknesses of the security image lines 24 are increased with respect to the line thicknesses of the background image lines 26 to offset the difference in spatial frequency so that the securing image 20 and the complementary background 22 exhibit the desired common visual density. Thus, the respective spatial frequencies of the security image 20 and complementary background 22 determine the relative sizes of the security image and background lines 24 and 26. The choice of common visual density collectively enlarges or collectively decreases the sizes of both the security image lines 24 and the background image lines 26.

Larger line thicknesses are expected to reproduce more easily than smaller line thicknesses, especially for low-resolution copiers or scanners. Such low-resolution platforms tend to acquire a limited number of samples per given area on the scanned or copied document. Lines sized to more completely fill a given sample size register at a higher reflectance contrast value than lines that less completely fill the same sample size. Especially upon conversion of the registered values to a binary image document where image pixels are recorded as either light or dark, the higher contrast reflectance values are more likely to be represented among the binary image pixels.

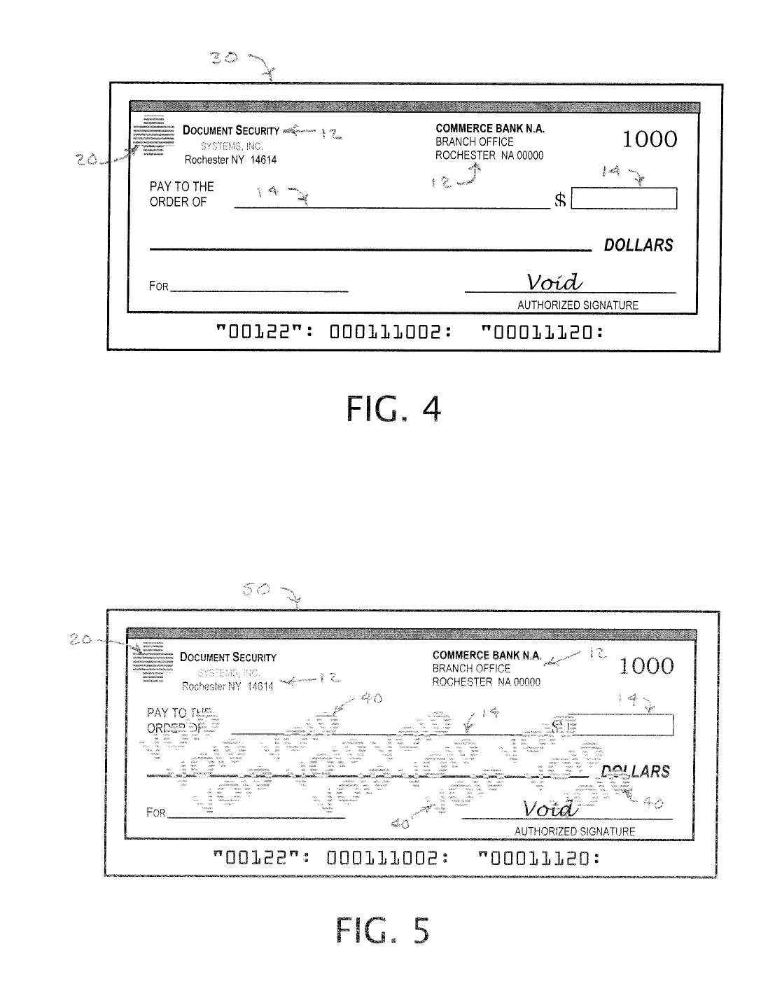

Thus, for purposes of printing the security image 20 in a form that survives scanning and conversion into an image replacement document 30 in binary image form as shown in FIG. 4, the dimensions of the security image lines 24 (FIG. 2) are set in relation to the expected unit sample processing size so that the security image lines 24 are represented among the converted (e.g., dark) pixels of the binary image. Conversely, the dimensions of the background lines 26 (FIG. 2) are set in relation to the expected unit sample processing size so the background lines 26 are not similarly represented among the converted pixels of the binary image to provide a contrast from which the security image 20 is visible.

Generally, the spatial frequencies for printing the security feature 20 are less than 105 lines per inch, and the spatial frequencies for printing the complementary background are more than 105 lines per inch. However, the two spatial frequencies of the security feature lines 24 and the background lines 26 must be sufficiently different and set in relation to the common visual density of the security feature 20 and the background 22 to exhibit sufficiently different reflectance values so that the reflectance sampled regions of the security image 20 are converted into a different ratio of dark vs. light pixels that the reflectance sampled regions of the background 20. Preferably, the spatial frequency of the security feature lines 24 are between 50 lines per inch and 85 lines per inch, and the spatial frequency of the background lines is between 150 lines per inch and 190 lines per inch.

For purposes of hiding the security image 20 within the complementary background 22, the differences between the line frequencies of the security feature lines 24 and the background lines 26 should be minimized. However, for purposes of accommodating a range of conversion platforms for converting the bank check 20 into an image replacement document 30 in binary image form, the differences between the line frequencies of the security feature lines 24 and the background lines 26 should be increased. The suggested ranges provide a good balance among these competing intentions.

The visual density of the overall background 18 is preferably less that 50 percent, and generally significantly less than 50 percent, so that the printed areas 12 and the later-printed or handwritten fillable areas 14 exhibit sufficient contrast with the background 18 to be both clearly seen on the physical bank check 10 and to survive the conversion as image compatible data elements within the image replacement document 30 in binary image form. The common visual density of the security image 20 and the background 22 is preferably in a range between 20 percent and 30 percent, which is low enough in relation to the spatial frequencies specified for the background lines 26, so that the background 18 drops out, i.e., (is not reproduced within the image replacement document 30) but is high enough in relation to the spatial frequencies specified for the security image lines 26, so that the security image 20 is reproduced within the image replacement document 30. At a preferred visual density of 25 percent, spatial frequencies of approximately 75 lines per inch for the security feature lines 24 and 180 lines per inch for the background lines 26 have been considered optimal for an intended application. The presence of the security image 20 within the image replacement document 30 is evidence of the authenticity of the image replacement document 30 as a commercial if not also legal equivalent of the bank check 10 in paper form.

While the security image 20 functions as a validating security feature, another security image 40 embedded in a complementary background 42 overlapping the area 3 of FIG. 1 and shown enlarged in FIG. 3 functions as an invalidating security feature. The invalidating security image 40 and its complementary background 42 can be printed using conventional (so-called pantograph technologies) for thwarting unauthorized reproductions of original documents. Counterfeiting and other unauthorized reproductions generally involve high-resolution copying intended for reproducing the original document in manner that appears the same as the original through at least cursory inspection.

High-resolution reproductions of original printed documents with conventional invalidating security images often results in revealing a hidden warning message, code, picture, portrait, design, or indicia within the reproduction or in producing a major distortion, color shift, moiré skewed image, or obvious omission within the reproduction. For example, high-resolution reproductions of an original can result in a complete drop out of printed details of the original on the reproduction, where the whole reproduction or a part thereof may reproduce as a solid color or multiple solid colors. Reproductions of an original can also result in a copy containing “shifted” single color images.

High-resolution reproductions produce color or grayscale images in which each pixel is capable of representing a range of tonal values, and within such images, conventional invalidating security images, which are otherwise hidden in the original printed document, appear as evidence of unauthorized copying. However, the known invalidating security images do not survive the further dynamic contrast image conversion that reduces image pixels to binary dark vs. light values.

Contrary to the purposes of conventional invalidating security images, the invention among its preferred embodiments does not seek to invalidate the image replacement document 30 as a copy of the bank check 10. Instead, the invention seeks to validate the conversion of original printed documents, such as the bank check 10, into the image replacement document 30 in a binary image form. In addition, the invention provides for exploiting the inability of known invalidating security images to survive the conversion of original printed documents into binary images.

The invalidating security image 40 together with its complementary background 42 is printed as a part of the background 18 occupying one or more sections of the check 10 that include one or both of the preprinted areas 12 or designated fillable areas 14. Within the bank check 10, as shown in FIG. 1, the invalidating security image 40 remains hidden. Within the image replacement document 30, as shown in FIG. 4, the invalidating security image 40 drops out along with the rest of the background 18. Thus, the invalidating security image 30 does not interfere with the reproduction of the bank check 10 as the image replacement document 30 or with the authentication of the bank check 10 as provided by the validating security image 20.

Nonetheless, the invalidating security image 40 together with its complementary background 42 provides an important function of distinguishing whether the bank check 10, which is subject to electronic conversion into the image replacement document 30, is itself an original or a an unauthorized copy. The invalidating security image 40 thwarts high-quality copying of the bank check 10 presented for electronic conversion by producing invalidating indications, such as the word “void”, in a form that is reproducible (i.e., image compatible) within a binary image. FIG. 5 depicts an electronic conversion of an unauthorized paper copy of the bank check 10 into an image replacement document 50 in binary image form. Within the image replacement document 50 the invalidating security images 40 are prominently shown obscuring data elements, such as the form fillable fields 14, which are necessary to process the bank check 10 successfully.

For authentication purposes, the presence of the validating security image 20 in the image replacement document 30 is evidence that the image replacement document 30 is a copy of the bank check 10, and the absence of the invalidating security image 40 in the image replacement document 30 is evidence that the image replacement document 30 is a first-generation reproduction of the bank check 10. Conversely, the absence of the validating security image 20 in the image replacement document 20 is evidence that the image replacement document 30 is not a copy of an accepted bank check, and the presence of the invalidating security image 40 in the image replacement document 50 is evidence that the bank check 10 is not an original.

The invalidating security image 40 and its complementary background 42 can be printed similar to the validating security image 20 and its complementary background 22. Similar angles and line frequencies can be used. The security image 40 and the background 42 also have a common visual density so that the security image 40 is at least partially indistinguishable from the background 42 to the naked eye.

However, the common visual density of the invalidating security image 40 and its background 42 (FIG. 3) is significantly less than the common visual density of the validating security image 20 and its background 22 (FIG. 2). For example, the common visual density of the validating security image 20 and its background 22 is preferably above 20 percent and preferably between 20 percent and 30 percent, and the common visual density of the invalidating security image 40 and its background 42 is preferably below 20 percent and preferably between 5 percent and 20 percent. The common visual density of the invalidating security image 40 and its background 42 is preferably significantly less than the common visual density of the validating security image 20 and its background 22 so that the dimensions of the security image lines 44 and background lines 46 are reduced in size relative to both (a) the security image lines 24 and the background lines 26 and (b) the expected sample sizes of the reflectance sampled regions of the bank check 10 so that neither the lines 44 of the security image 40 nor the lines 44 of the background 42 survive the conversion of the bank check 10 into the image replacement document 30 in binary image form. According to a preferred application, the common visual density of the validating security image 20 and its background 22 is approximately 25 percent, and the common visual density of the validating security image 20 and its background 22 is approximately 14 or 15 percent.

Although in the illustrated embodiment, the invalidating security image 40 and its background 42 have been depicted with similar line frequencies and relative angular orientation as the validating security feature 20 and its background 22, particularly for purposes of distinguishing the effects of varying the common visual densities between the two security features, the invalidating security image 40 and its background 42 can be formed at a variety of different angles and line frequencies, including multiple line frequencies and colors and overprinting designs in between, around, or overtop existing line structures. The invalidating security image 40, however formed, is required to survive higher-resolution copying according to its design but to not survive the lower-resolution conversion into a binary image.

In the illustrated embodiment, the background 22 of the validating security image 20 has a different visual density than the background 22 of the invalidating security image 20. However, within the overall background 20 the two visual densities can be blended or otherwise mixed to integrate the two backgrounds 22 and 42. A common background having a single or varied visual density could also be used to obscure both the validating security feature 20 and the invalidating security feature 40, since the preferred role of the background in both instances is to drop out of the image replacement document 30. Other adjustments to line frequencies and angles can be made to hide the security features 20 and 40 while still performing their respective functions. The security images could be hidden within other images that form effective backgrounds for the security images.

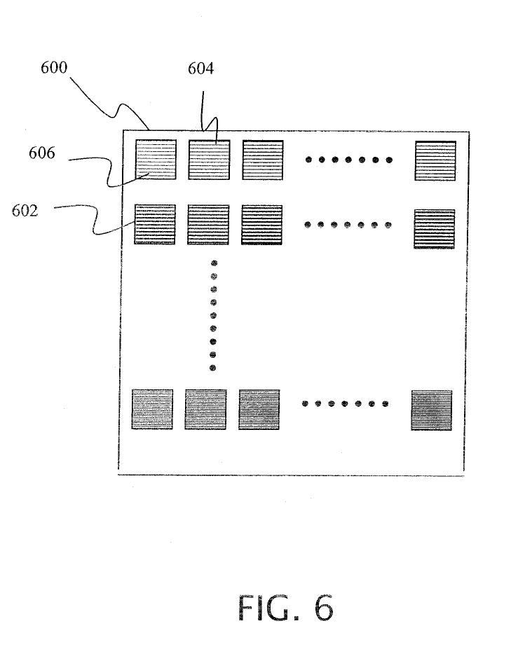

Reference is now made to FIG. 6, which illustrates an exemplary test pattern 600 that may be used to determine survivable and non-survivable spatial frequencies of scanning devices and their processing platforms, and determine interfering, non-interfering, and partially interfering frequencies. Test pattern 600 has a plurality of rows 602 of different lines, dots, spots or images having frequencies ranging, for example, from about 25 lines per inch to about 400 lines per inch each row 602 having a separate line frequency. Each row 602 has a series of blocks 604 ranging in visual densities from, for example, about 10% to 80%. When test pattern 600 is scanned, the scanner operator can view the scanned copy to determine which spatial line frequencies and corresponding visual densities provide a survivable image, and/or which spatial frequencies provide interfering and non-interfering printed lines, dots, spots, images, artwork, or indicia. The spatial line frequencies and visual densities that provide a survivable image may be used as the frequencies and densities for a latent security image 20. Accordingly, even if conventional scanning devices are modified in a manner which alters their current survivable frequencies, newly created survivable scanning frequencies may be readily identified.

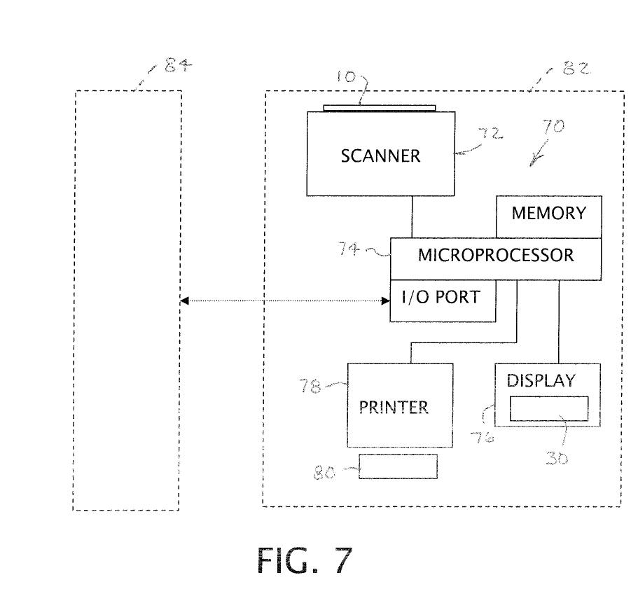

FIG. 7 depicts a document processing system 70 for converting an original printed document, such as the bank check 10, into an image replacement document 30 in binary image form. A conventional bank scanner 72 scans the bank check 10 into a microprocessor 74. Generally such conventional bank scanners 72 include an image sensor array (not shown) that measures reflectance values from corresponding sampled regions of the scanned document, e.g., the bank check 10, through a set of optics (not shown). An analog-to digital converter (also not shown) converts the analog reflectance values into digital values within a digital array. The digital values are further processed by a dynamic image contrast conversion algorithm for generating a binary image of dark or light pixels by comparing the recorded reflectance values to a threshold. The threshold itself can be varied according to other criteria, including measured or processed values of the scanned document or by different sub-groupings of the samples. The result of the scan of the bank check 10 and subsequent processing is the image replacement document in binary image form viewable on a display 76 or further reproducible on paper by a printer 78 as a substitute check 80, having legal equivalency with the original bank check 10.

Conventional bank scanning devices, such as the scanner 72, scan documents in geometric horizontal and vertical directions, input reflectance values from a image sensor array, and, together with a processor, produce pixels used to make a binary image. The term “scanning device” is used hereafter to refer to any device that performs an optical scan to obtain an image of a document, including photocopying and scanning equipment. Most copying and scanning equipment in use by the banking industry are high speed, low-resolution scanners that may scan thousands of checks each day. These scanners produce a binary image of the checks, generally as a bit map image, and the binary image of the check is stored as the deposited copy of the checks. These commercial bank scanners, such as NCR scanners, generally scan at a frequency below 300 dots (samples) per inch (dpi) and average 200 samples per inch to 240 samples per inch.

The print elements of the security image 20, e.g., the lines 24, are sized in relation to both the corresponding print elements of the background 22, e.g., the lines 26, and the size of the reflectance-sampled regions of the original printed document, e.g., the bank check 10 so that the reflectance sampled regions of the security image 20 exhibit more highly contrasting reflectance values than the reflectance-sampled regions of the background 22. The conversion algorithm generates a binary image from the reflectance values of the reflectance sampled regions such that the more highly contrasting reflectance values of the security image 20 are converted into a higher ration of dark vs. light pixels than the less highly contrasting reflectance values of the background 22. Generally, the ratio of dark vs. light pixels in the background is reduced with respect to the ratio of dark vs. light pixels in the security image 20, so that the security image 20 is reproduced in the image replacement document and the background 22 is not. The security image 20 as it appears in the image replacement document can be detected for purposes of authentication.

Once in electronic form as a binary image, the image replacement document 30 can be transmitted to another financial institution, for example, from a depositing bank 82 to the payor bank 84 to effect a funds transfer to the payee. The electronic transmission of the image replacement document 30 replaces the need to physically return the deposited bank check 10 to its originating institution, the payer bank.

For producing the security images 20 or 40, a bank's check printer can be arranged to print on the face of the check 10 one or more background patterns that incorporate the principles of the invention. Thus, the banking industry will not have to convert or upgrade their current check printing or processing hardware to benefit from the invention. Banks only need to change the printing of the check itself by directing their check printers to incorporate the present inventive techniques into the printing process. The fact that the banking industry will not have to invest in new and expensive software and hardware detection systems is an important benefit of this embodiment of the present invention.

Although a bank check 10 is the preferred original printed document of the illustrated embodiment, the original printed document can be of various types, including a security note or other financial instruments, corporate, tax and real estate transactions or other dealings, public records, and publications for which security protection is needed. In fact, any original printed document can be printed so to incorporate the disclosed protections.

The security images 20 and 40, which are constructed by single sets of lines, can also be formed by multiple lines including lines of different colors matching background patterns formed from one or more sets of lines of a single color or multiple colors. Typically, conventional bank scanners can scan all colors except yellow by converting them to a bit map and turning them to black. Therefore, lines of any color or combination of colors (except yellow alone) can be used in practicing this embodiment of the present invention.

In addition to facilitating banking or other financial, business, or government transactions, the new security features can be used for authenticating and verifying archived documents, either in original form capable of producing verifiable electronic reproductions or in electronic form as authenticated image replacement documents. Archive management can authorize third party access to authenticated electronic images.

Those of skill in the art will appreciate that a variety of security images can be printed in accordance with the principles of the present invention to validate image replacement documents for original printed documents and to invalidate unauthorized copies of the original printed documents.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes, which come within the meaning and range of equivalency of the claims, are therefore intended to be embraced therein.

1. A document processing system in which a security image embedded in an original printed document survives a conversion process into an image replacement document in binary image form having a commercial or legal equivalency with the original printed document, comprising
the original printed document containing the security image being embedded in a background at an approximately common visual density with the background so that the security image is at least partially indistinguishable from the background to the naked eye,
both the security image and the background being formed by an arrangement of relatively oriented print elements,
the print elements of the security image being arranged at a different spatial frequency than the print elements of the background, and
the approximately common visual density being set in relation to the different spatial frequencies such that upon conversion into the image replacement document in binary image form, the security image is converted into a different ratio of dark vs. light pixels than the background and thereby becomes more readily distinguishable from the background.

2. The system of claim 1 in which the ratio of dark vs. light pixels in the background is reduced with respect to the ratio of dark vs. light pixels in the security image upon conversion into the image replacement document in binary image form.

3. The system of claim 1 in which the dark and light pixels within the binary image correspond to reflectance-sampled regions of the original printed document, and the security image print elements are sized in relation to both the background print elements and the reflectance-sampled regions so that the reflectance-sampled regions of the security image exhibit more highly contrasting reflectance values than the sampled regions of the background.

4. The system of claim 1 in which the print elements of the security image are oriented in a first direction and have a first spatial frequency, and the print elements of the background are oriented in a second direction and have a second frequency that is one half or less than the first frequency.

5. The system of claim 4 in which the approximately common visual density of the security image and the background is less than 50 percent.

6. The system of claim 4 in which the approximately common visual density of the security image and the background is between 20 percent and 30 percent.

7. The system of claim 4 in which the first frequency is less than 105 lines per inch and the second frequency of the background print elements is greater than 105 lines per inch.

8. The system of claim 4 in which the first frequency is between 50 lines per inch and 85 lines per inch and the second frequency is between 150 lines per inch and 190 lines per inch.

9. The system of claim 4 in which the first frequency is approximately 75 lines per inch and the second frequency is approximately 180 lines per inch.

10. The system of claim 1 in which the security image includes at least one of a message, code, picture, portrait, design, or indicia.

11. The system of claim 1 in which the image replacement document is capable of being reproduced in a paper form for meeting requirements for legal equivalence with the original printed document under the Check Clearing for the 21^{st} Century Act of 2004.

12. The system of claim 1 in which the security image is a first of more than one security image, the background is a first of more than one background, and a second of the more than one security images and a second of the more than one background exhibit an approximately common visual density so that the second security image is at least partially indistinguishable from the background to the naked eye.

13. The system of claim 12 in which the common visual density of the second security image and the second background is less than the common visual density of the first security image and the first background.

14. The system of claim 12 in which the common visual density of the second security image and the second background is less than 20 percent, and the common visual density of the first security image and the first background is more than 20 percent.

15. The system of claim 12 in which the common visual density of the second security image and the second background is between 5 percent and 20 percent, and the common visual density of the first security image and the first background is between 20 percent and 30 percent.

16. The system of claim 12 in which print elements of the first and second backgrounds have matching visual densities.

17. The system of claim 16 in which print elements of the first and second backgrounds have matching spatial frequencies, and print elements of the first and second security images have different spatial frequencies.

18. The system of claim 12 in which both the first security image and the second security image have visual densities and print elements relatively arranged to survive a grayscale reproduction of the original printed document in a paper form, the first security image also has a visual density and print elements relatively arranged to survive a dynamic contrast image conversion of the original printed document into the image replacement document in binary image form, but the second security image does not have a visual density and print elements relatively arranged to survive the same dynamic contrast image conversion of the original printed document into the image replacement document in binary image form.

19. The system of claim 18 in which the second background reduces in contrast with respect to the second security image upon the grayscale reproduction into a paper form.

20. The system of claim 18 in which the second security image survives a dynamic contrast image conversion of the paper form of the grayscale reproduction into the image replacement document in binary image form.

21. The system of claim 20 in which the first security image is a validating security image, and the second security image is an invalidating security image, such that the appearance of the second security image in either (a) the paper form of the grayscale reproduction or (b) the binary image form of the image replacement document is indicative of an unauthorized reproduction.

22. A method of authenticating image replacement documents as commercial or legal equivalents of original printed documents, comprising steps of:
scanning an original printed document containing a security image embedded in a background at an approximately common visual density with the background such that the security image is at least partially indistinguishable from the background to the naked eye,
acquiring reflectance values from reflectance-sampled regions of the scanned original printed document,
sizing print elements of the security image in relation to both print elements of the background and the reflectance-sampled regions of the scanned original print document such that the reflectance-sampled regions of the security image exhibit more highly contrasting reflectance values than the reflectance-sampled regions of the background,
generating an image replacement document in binary image form from the reflectance values of the reflectance-sampled regions of the scanned original printed document such that the more highly contrasting reflectance values of the reflectance-sampled regions of the security image are converted into a different ratio of dark vs. light pixels than the reflectance-sampled regions of the background, thereby rendering the security image more readily distinguishable from the background, and
detecting the security image in the image replacement document to verify the authenticity of the image replacement document as a commercial equivalent of the original printed document.

23. The method of claim 22 in which the ratio of dark vs. light pixels in the background is reduced with respect to the ratio of dark vs. light pixels in the security image within the image replacement document in binary image form.

24. The method of claim 22 in which the step of generating includes comparing the reflectance values to a threshold such that a different percentage of the reflectance values of the reflectance-sampled regions of the security image meet the threshold than the reflectance values of the reflectance-sampled regions of the background.

25. The method of claim 22 including a step of printing the security image and the background as arrangements of relatively oriented print elements, wherein the print elements of the security image are arranged at a lower spatial frequency than the print elements of the background.

26. The method of claim 25 system of claim 1 in which the spatial frequency of the security feature print elements is one half or less than the spatial frequency of the background print elements.

27. The method of claim 25 in which the spatial frequency of the security feature print elements is between 50 lines per inch and 85 lines per inch and the spatial frequency of the background print elements is between 150 lines per inch and 190 lines per inch.

28. The method of claim 25 in which the spatial frequency of the security feature print elements is approximately 75 lines per inch and the spatial frequency of the background print elements is approximately 180 lines per inch.

29. The method of claim 25 in which the approximately common visual density of the security image and the background is less than 50 percent.

30. The method of claim 27 in which the approximately common visual density of the security image and the background is between 20 percent and 30 percent.

31. The method of claim 28 in which the approximately common visual density is approximately 25 percent.

32. The method of claim 22 in which the print elements of the security image and the background are oriented relative to each other through an angle of at least five degrees.

33. The method of claim 22 in which the security image is a security icon that appears to the naked eye in an unobtrusive section of the image replacement document.

34. The method of claim 22 in which the step of detecting includes reproducing the image replacement document in a paper form that meets requirements for legal equivalence under the Check Clearing for the 21^{st} Century Act of 2004.

35. The method of claim 34 in which the original printed document is an endorsed paper check and the image replacement document in paper form is a substitute check in accordance with the act.

36. The method of claim 35 in which the security image is a security icon that is not readily visible to the naked eye in the original paper check but appears visible to the naked eye in an unobtrusive section of the substitute check.

37. The method of claim 22 in which the step of acquiring reflectance values from reflectance-sampled regions of the scanned original printed document includes acquiring the reflectance values from the sampled regions at a density of no more than 300 samples per inch.

38. The method of claim 22 in which the security image is a first of more than one security image, the background is a first of more than one background, and a second of the more than one security images and a second of the more than one backgrounds exhibit an approximately common visual density so that the second security image is at least partially indistinguishable from the second background to the naked eye.

39. The method of claim 38 in which the common visual density of the second security image and the second background is less than the common visual density of the first security image and the first background such that the second security image does not survive as a distinguishable feature in the image replacement document through the step of generating the image replacement document in binary image form based on the reflectance values of the reflectance-sampled regions of the scanned original printed document.

40. The method of claim 38 in which the first security image is a validating security image, and the second security image is an invalidating security image, such that an appearance of the second security image in the image replacement document is indicative of an unauthorized reproduction of the original printed document.

41. The method of claim 38 in which print elements of the second security image are sized in relation to both print elements of second background and the print elements of the first security image such that the reflectance-sampled regions of the first security image exhibit more highly contrasting reflectance values than reflectance-sampled regions of the second security image, and the second security image does not survive as a distinguishable feature in the image replacement document through the step of generating the image replacement document in binary image form based on the reflectance values of the reflectance-sampled regions of the scanned original printed document.

42. The method of claim 41 the common visual density of the second security image and the second background is substantially the same as the common visual density of the first security image and the first background.

43. An original printed document for practicing the method of claim 22 comprising
a security image embedded in a background of the original printed document at an approximately common visual density with the background such that the security image is at least partially indistinguishable from the background to the naked eye, and
print elements of the security image being sized in relation to both print elements of the background and the reflectance-sampled regions of the scanned original print document such that the reflectance-sampled regions of the security image exhibit more highly contrasting reflectance values than the reflectance-sampled regions of the background,

44. A document having survivable and non-survivable security images comprising
a validating security image embedded in a first background of the document at an approximately common visual density so that the validating security image is at least partially indistinguishable from the first background to the naked eye,
an invalidating security image embedded in a second background at an approximately common visual density so that the invalidating security image is at least partially indistinguishable from the second background to the naked eye,
the two security images and the two backgrounds being formed by arrangements of relatively oriented print elements having respective spatial frequencies,
the validating and invalidating security images having at least one of different spatial frequencies and different visual densities, and
the visual densities of the validating and invalidating security images being set in relation to the spatial frequencies of the validating and invalidating security images so that the validating security image survives a conversion of the document into an electronic form and the invalidating security image does not similarly survive the same conversion into the electronic form.

45. The document of claim 44 in which the common visual density of the validating security image and the first background is more than 20 percent, and the common visual density of the invalidating security image and the second background is less than 20 percent.

46. The document of claim 44 in which the common visual density of the validating security image and the first background is between 20 percent and 30 percent, and the common visual density of the invalidating security image and the second background is between 5 percent and 20 percent.

47. The document of claim 44 in which the visual density of the first background matches the visual density of the second background, and the spatial frequency of the print elements of the validating security image is less than the spatial frequency of the print elements of the invalidating security image.

48. The document of claim 44 in which both the validating security image and the invalidating security image have visual densities and print elements relatively arranged to survive a higher-information-content reproduction of the document in a paper form, the validating security image also has a visual density and print elements relatively arranged to survive a lower-information-content conversion of the document into the electronic form, but the invalidating security image does not have a visual density and print elements relatively arranged to survive the same lower-information-content conversion of the document into the electronic form.

49. The document of claim 48 in which the invalidating security image survives a lower-information-content conversion of the paper form of the higher-information-content reproduction into the electronic form.

50. The document of claim 49 in which the appearance of the invalidating security image in either (a) the paper form of the higher-information-content reproduction or (b) the electronic form of the lower-information-content conversion is indicative of an unauthorized reproduction.

51. The document of claim 44 in which the validating security image and the invalidating security image are located in adjacent portions of the document and a joined by a third background that blends the higher common visual density of the validating security image and the first background with the lower common visual density of the invalidating security image and the second background.

52. A printed document containing security features for authenticating an image replacement document that is electronically converted from the printed document, comprising
a validating security feature and an invalidating security feature embedded in the printed document in forms that are at least partially invisible to the naked eye,
the validating security feature being arranged to survive a conversion of the printed document into a binary image,
the invalidating security feature being arranged to survive a conversion of the printed document into a grayscale reproduction but to not survive the conversion of the printed document into the binary image.

53. The printed document of claim 52 in which the validating security feature is located in an unobtrusive section of the printed document to avoid obscuring otherwise printed regions of the printed document, and the invalidating security feature is located in an obtrusive section of the printed document to at least partially obscure the otherwise printed regions of the printed document upon the conversion into the grayscale reproduction.

54. The printed document of claim 52 in which the invalidating security feature is arranged to survive a further conversion of the grayscale reproduction of the printed document into the binary image as evidence of an unauthorized reproduction of the printed document.

55. The printed document of claim 52 in which the printed document is a paper check, and the image replacement document meets requirements of the Check Clearing Act for the 21^{st} Century of 2004 for an electronic conversion of the paper check.

56. The printed document of claim 55 in which the image replacement document is based on the binary image.

57. A method of creating authenticating image replacement documents as commercial equivalents of original printed documents comprising
embedding a security image in a background of an original printed document at an approximately common visual density with the background so that the security image is at least partially indistinguishable from the background to the naked eye,
forming both the security image and the background by an arrangement of relatively oriented print elements,
arranging the print elements of the security image at a different spatial frequency than the print elements of the background, and
setting the common visual density in relation to the different spatial frequencies so that upon conversion of the original printed document into the image replacement document in a binary image form, the security image is converted into a different ratio of dark vs. light pixels than the background and thereby becomes more readily distinguishable from the background.

58. The method of claim 57 in which the common visual density is set in relation to the different spatial frequencies so that the ratio of dark vs. light pixels in the background is reduced with respect to the ratio of dark vs. light pixels in the security image upon conversion into the image replacement document in binary image form.

59. The method of claim 57 in which the step of arranging includes arranging the print elements of the security image at a first spatial frequency and arranging the print elements of the background at a second spatial frequency that is one half or less than the first frequency.

60. The method of claim 57 in which the first frequency is between 50 lines per inch and 85 lines per inch and the second frequency is between 150 lines per inch and 190 lines per inch.

61. The method of claim 57 in which the common visual density of the security image and the background is between 20 percent and 30 percent.

62. The method of claim 57 in which the security image is a first of more than one security image, the background is a first of more than one background, and including a step of embedding a second of the more than one security images within a second of the more than one background at an approximately common visual density so that the second security image is at least partially indistinguishable from the background to the naked eye.

63. The method of claim 62 in which the common visual density of the second security image and the second background is less than the common visual density of the first security image and the first background.

64. The method of claim 62 in which the step of arranging includes arranging print elements of both the first security image and the second security image to survive a grayscale reproduction of the original printed document in a paper form, arranging the print elements of the first security image to survive a dynamic contrast image conversion of the original printed document into the image replacement document in binary image form, and arranging the print elements of the second security image not to survive the same dynamic contrast image conversion of the original printed document into the image replacement document in binary image form.
